(19) United States
(12) Patent Application Publication
(10) Pub. No.: US 2026/0035891 A1
(43) Pub. Date: Feb. 5, 2026

(54) STACKED BACKFLOW PREVENTER AND DIVERTER FOR SAME

(71) Applicant: Zurn Water, LLC, Milwaukee, WI (US)

(72) Inventors: Christopher J. Corral, Paso Robles, CA (US); Travis S. Williams, Templeton, CA (US); Joy Lane, Paso Robles, CA (US); Brian D. Yale, Morro Bay, CA (US); William M. Orr, Paso Robles, CA (US); Matthew G. Guise, Atascadero, CA (US); Christopher A. Bruni, Atascadero, CA (US); Edward A. Stettler, Atascadero, CA (US); Jonathan M. Mankins, Atascadero, CA (US)

(21) Appl. No.: 19/288,700

(22) Filed: Aug. 1, 2025

Related U.S. Application Data
(60) Provisional application No. 63/678,809, filed on Aug. 2, 2024.
(60) Provisional application No. 63/775,210, filed on Mar. 20, 2025.

(51) Int. Cl. E03B 7/07; F16K 15/06

(52) U.S. Cl. CPC E03B 7/077; F16K 15/06

(57) ABSTRACT

A backflow preventer includes an inlet and an outlet positioned in a stacked configuration with respect to the inlet, the outlet positioned downstream of the inlet with respect to a flow path in which fluid flows from the inlet to the outlet. The backflow preventer further includes a first check valve located between the inlet and the outlet with respect to the flow path, and a second check valve located between the first check valve and the outlet with respect to the flow path. The backflow preventer includes a coupling portion providing fluid communication between the inlet and the outlet, and a diverter positioned between the inlet and the outlet. The diverter includes a baffle that inhibits fluid backflow from the outlet to the inlet.

### CROSS-REFERENCE TO RELATED APPLICATIONS

This application claims the benefit of U.S. Provisional Patent Application No. 63/678,809 filed Aug. 2, 2024 and U.S. Provisional Patent Application No. 63/775,210 filed Mar. 20, 2025, the entire contents of which are incorporated by reference herein.

### TECHNICAL FIELD

The present application relates to a backflow preventer, and more particularly, a stacked backflow preventer.

### BACKGROUND

Backflow preventers permit forward fluid flow through the backflow preventer while preventing backflow or back-siphonage of contaminated fluid. Backflow preventers can be used to protect potable water supplies from contaminants that could otherwise be introduced into the potable water via back-siphonage or back-pressure.

### SUMMARY

In one independent aspect, a backflow preventer includes: an inlet; an outlet positioned in a stacked configuration with respect to the inlet, the outlet positioned downstream of the inlet with respect to a flow path in which fluid flows from the inlet to the outlet; a first check valve located between the inlet and the outlet with respect to the flow path; a second check valve located between the first check valve and the outlet with respect to the flow path; a coupling portion providing fluid communication between the inlet and the outlet; and a diverter positioned between the inlet and the outlet, the diverter including a baffle that inhibits fluid backflow from the outlet to the inlet.

In some aspects, the baffle directs fluid backflow toward a periphery of the coupling portion.

In some aspects, the first check valve includes a frame, a portion of the frame spaced from a side wall of the coupling portion to form a cavity, and wherein fluid backflow diverted to the periphery of the coupling portion can accumulate in the cavity.

In some aspects, the coupling portion includes a discharge port for receiving fluid backflow, wherein the baffle directs fluid backflow toward the discharge port.

In some aspects, the discharge port is located proximate an upstream end of the coupling portion.

In some aspects, the first check valve includes a frame and a valve body, the valve body being removable from the frame while the frame remains mounted in the coupling portion, wherein the baffle is one of a plurality of baffles, and wherein a cross sectional area of the valve body is blocked from fluid backflow by the plurality of baffles.

In some aspects, the coupling portion includes an access port, wherein the diverter is insertable through the access port.

In some aspects, the access port includes a removable cover, and wherein the diverter is shaped such that it can be removed from the coupling portion through the access port when the removable cover is removed.

In some aspects, the access port includes a removable cover, and wherein the diverter is attached to the removable cover.

In some aspects, the diverter includes a first baffle and a second baffle, the second baffle being movable between a first position and a second position.

In some aspects, fluid flow in a downstream direction biases the second baffle to the second position, wherein the second baffle returns to the first position in the absence of fluid flow in the downstream direction.

In some aspects, the diverter includes a plurality of flaps, the plurality of flaps movable between a first configuration and a second configuration, the plurality of flaps engaging each other to block fluid flow in the first configuration, and the plurality of flaps at least partially spaced apart to form an opening for allowing fluid flow therethrough in the second configuration.

In some aspects, fluid flow in a downstream direction can bias the plurality of flaps from the first configuration to the second configuration.

In some aspects, the diverter is rotatably coupled to a sidewall of the coupling portion.

In some aspects, the diverter is movable between a first position and a second position, the second position being less obstructive to fluid flow in a downstream direction than the first position, the first position of the diverter obstructing fluid backflow from the outlet from passing through the first check valve.

In some aspects, the diverter includes a first plate and a second plate each rotatable about a pivot member.

In some aspects, the diverter includes a floating member, the floating member sealing against a seat in the absence of fluid flow in a downstream direction.

In some aspects, the floating member is a sphere.

In some aspects, the coupling portion includes a receptacle offset from an inlet axis, the receptacle configured to retain the floating member in conditions of fluid flow in the downstream direction.

In some aspects, the diverter includes a helical panel, the helical panel prohibiting fluid flow in a direction parallel to an inlet axis through the diverter.

In some aspects, the diverter includes a plate having a plurality of openings therethrough, each of the plurality of openings having a nozzle.

In some aspects, the nozzles are configured to allow fluid flow through the plurality of openings in a downstream direction and to prohibit fluid flow through the plurality of openings in a backflow direction.

In some aspects, the diverter is positioned between the first check valve and the second check valve.

In some aspects, the diverter is positioned between the second check valve and the outlet.

In some aspects, the backflow preventer further comprises a discharge port positioned between the diverter and the outlet.

In some aspects, the backflow preventer further comprises a first discharge port positioned between the diverter and the outlet; and a second discharge port positioned between a portion of the first check valve and the second check valve.

In some aspects, the first discharge port and the second discharge port are each coupled to a single relief valve.

In another independent aspect, a backflow preventer includes: an inlet; outlet positioned in a stacked configuration with respect to the inlet; a pipe section, the pipe section housing a first check valve and a second check valve downstream of the first check valve; a diverter positioned between the first check valve and the second check valve, the diverter including a baffle that inhibits fluid backflow from a central portion of the pipe section and diverts fluid backflow to a periphery of the pipe section; and a discharge port in a side wall of the pipe section.

In some aspects, the discharge port is located proximate the first check valve, the discharge port fluidly downstream of the first check valve.

In some aspects, the first check valve includes a frame, a portion of the frame spaced from the side wall of the pipe section to form a cavity, and wherein fluid backflow diverted to the periphery of the pipe section can accumulate in the cavity.

In some aspects, the first check valve includes a frame and a valve body, the valve body being removable from the frame while the frame remains mounted in the pipe section, wherein the baffle is one of a plurality of baffles, and wherein a cross sectional area of the valve body is blocked from fluid backflow by the plurality of baffles.

In some aspects, the pipe section includes an access port, wherein the diverter includes a base portion that is at least partially received in the access port.

In some aspects, the access port includes a removable cover, and wherein the diverter is shaped such that it can be removed from the pipe section through the access port when the removable cover is removed.

In yet another independent aspect, a backflow preventer includes: a pipe section having an inlet and an outlet, the inlet and the outlet being arranged in a stacked configuration, the pipe section housing a first check valve and a second check valve downstream of the first check valve; a discharge port in a sidewall of the pipe section; and a diverter positioned between the first check valve and the second check valve, the diverter including a baffle that blocks fluid backflow from a central portion of the pipe section and diverts the fluid backflow to a periphery of the pipe section.

In some aspects, the baffle is angled such that fluid backflow is guided towards the discharge port.

In some aspects, the diverter includes an end wall adjacent the sidewall of the pipe section, wherein a lower portion of the baffle and a lower portion of the end wall are connected to at least partially form a cavity for accumulating fluid backflow, and wherein the diverter includes a mouth at a lower end of the cavity for discharging fluid backflow.

In some aspects, the mouth is aligned with the discharge port to direct fluid backflow to the discharge port.

In some aspects, the pipe section includes an access port, wherein the diverter includes a base portion that is at least partially received in the access port.

In some aspects, the diverter includes an end wall opposite the base portion, and wherein the end wall abuts the sidewall of the pipe section and the base portion at least partially engages the access port to retain the diverter in the pipe section.

In some aspects, the diverter includes a first baffle and a second baffle, the second baffle movable relative to the second baffle.

In still another independent aspect, a backflow preventer includes: an inlet; an outlet aligned with the inlet in a stacked configuration; a coupling portion providing fluid communication between the inlet and the outlet, the coupling portion including a first check valve and a second check valve, the first check valve positioned upstream of the second check valve, the first check valve including a first valve component moveable between engaging an upper end of a first valve frame to prohibit flow through the first check valve and being at least partially spaced apart from the upper end of the first valve frame to permit flow through the first check valve; and a discharge port for expelling fluid from the outlet, the discharge port positioned on a sidewall of the coupling portion and at least partially upstream of the upper end of the first valve frame.

In some aspects, the discharge port is elongated in a direction that is perpendicular to a fluid flow direction from the inlet to the outlet.

In some aspects, the discharge port is positioned entirely upstream of the upper end of the first valve frame.

Other aspects of the disclosure will become apparent by consideration of the detailed description and accompanying drawings.

### BRIEF DESCRIPTION OF THE DRAWINGS

FIG. 1 is a perspective view of a backflow preventer according to one embodiment.

FIG. 2 is a partial section view of the backflow preventer of FIG. 1, viewed along section 2-2.

FIG. 3 is a partial perspective view of the backflow preventer of FIG. 1 without an access cover and with a diverter partially removed.

FIG. 4 is a perspective view of a diverter according to another embodiment, the diverter shown partially removed from a portion of a backflow preventer.

FIG. 5 is a section view of the diverter of FIG. 4 shown installed in a portion of a backflow preventer, viewed along section 5-5.

FIG. 6 is a perspective view of the diverter of FIG. 4.

FIG. 7 is a section view of a diverter according to another embodiment, installed in a backflow preventer.

FIG. 8 is a perspective view of the diverter of FIG. 7.

FIG. 9 is a perspective view of a diverter according to another embodiment, shown in a first configuration.

FIG. 10 is a section view of the diverter of FIG. 9, viewed along section 10-10.

FIG. 11 is a perspective view of the diverter of FIG. 9, shown in a second configuration.

FIG. 12 is a section view of the diverter of FIG. 11, viewed along section 12-12.

FIG. 13 is a perspective view of a diverter according to another embodiment.

FIG. 14 is a perspective view of a backflow preventer having a discharge outlet according to another embodiment.

FIG. 15 is an enlarged perspective view of the discharge outlet of FIG. 14.

FIG. 16 is a perspective view of a backflow preventer according to another embodiment.

FIG. 17 is a perspective view of a diverter of the backflow preventer of FIG. 16, the diverter shown in a first configuration.

FIG. 18 is a perspective view of a diverter of the backflow preventer of FIG. 16, the diverter shown in a second configuration.

FIG. 19 is a section view of the backflow preventer of FIG. 16, viewed along section A-A, the diverter shown in the first configuration of FIG. 17.

FIG. 20 is a section view of the backflow preventer of FIG. 16, viewed along section A-A, the diverter shown in the second configuration of FIG. 18.

FIG. 21 is a perspective view of a backflow preventer according to another embodiment.

FIG. 22 is a perspective view of a diverter of the backflow preventer of FIG. 21.

FIG. 23 is a section view of a portion of the backflow preventer of FIG. 21, viewed along section B-B, the diverter shown in a first configuration.

FIG. 24 is a section view of a portion of the backflow preventer of FIG. 21, viewed along section B-B, the diverter shown in a second configuration.

FIG. 25 is a section view of a backflow preventer according to another embodiment, a diverter of the backflow preventer shown in a first configuration.

FIG. 26 is a section view of the backflow preventer of FIG. 25, the diverter of the backflow preventer shown in a second configuration.

FIG. 27 is a section view of a backflow preventer according to another embodiment, a diverter of the backflow preventer shown in a first configuration.

FIG. 28 is a section view of the backflow preventer of FIG. 27, the diverter of the backflow preventer shown in a second configuration.

FIG. 29 is a section view of a backflow preventer according to another embodiment, a diverter of the backflow preventer shown in a first configuration.

FIG. 30 is a section view of the backflow preventer of FIG. 29, the diverter of the backflow preventer shown in a second configuration.

FIG. 31 is a section view of a backflow preventer according to another embodiment, a diverter of the backflow preventer shown in a first configuration.

FIG. 32 is a section view of the backflow preventer of FIG. 31, the diverter of the backflow preventer shown in a second configuration.

FIG. 33 is a section view of a backflow preventer according to another embodiment, a diverter of the backflow preventer shown in a first configuration.

FIG. 34 is a section view of the backflow preventer of FIG. 33, the diverter of the backflow preventer shown in a second configuration.

FIG. 35 is a section view of a backflow preventer according to another embodiment, a diverter of the backflow preventer shown in a first configuration.

FIG. 36 is a section view of the backflow preventer of FIG. 35, the diverter of the backflow preventer shown in a second configuration.

FIG. 37 is a section view of a backflow preventer according to another embodiment.

FIG. 38 is a perspective view of a diverter of the backflow preventer of FIG. 37.

FIG. 39 is a section view of a backflow preventer according to another embodiment.

FIG. 40 is a perspective view of a diverter of the backflow preventer of FIG. 39.

FIG. 41 is a section view of a backflow preventer according to another embodiment, a diverter of the backflow preventer shown in a first configuration.

FIG. 42 is an enlarged section view of a portion of the backflow preventer of FIG. 41.

FIG. 43 is a section view of the backflow preventer of FIG. 41, a diverter of the backflow preventer shown in a second configuration.

FIG. 44 is an enlarged section view of a portion of the backflow preventer of FIG. 43.

FIG. 45 is a partially exploded perspective view of a backflow preventer according to another embodiment.

FIG. 46 is a partially exploded perspective view of a backflow preventer according to another embodiment.

### DETAILED DESCRIPTION

Before any embodiments are explained in detail, it is to be understood that the disclosure is not limited in its application to the details of the configuration and arrangement of components set forth in the following description or illustrated in the accompanying drawings. The disclosure is capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof, as well as possible additional items. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

A backflow preventer, such as a reduced pressure (RP) backflow preventer, can be installed to prevent backflow in piping or plumbing systems. A backflow preventer can include two check valves installed in series to prevent backflow. A backflow preventer can also include a relief outlet or discharge outlet, which may be coupled to a relief valve or other valve, positioned between the check valves to expel contaminants or hazardous water downstream of the backflow preventer (e.g., to atmosphere or to a collector for disposing of hazardous water).

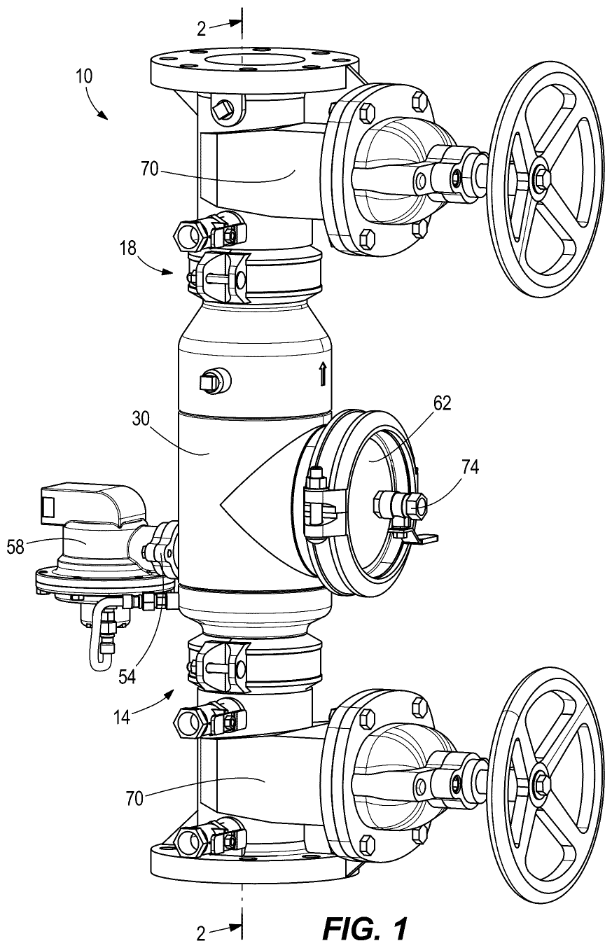

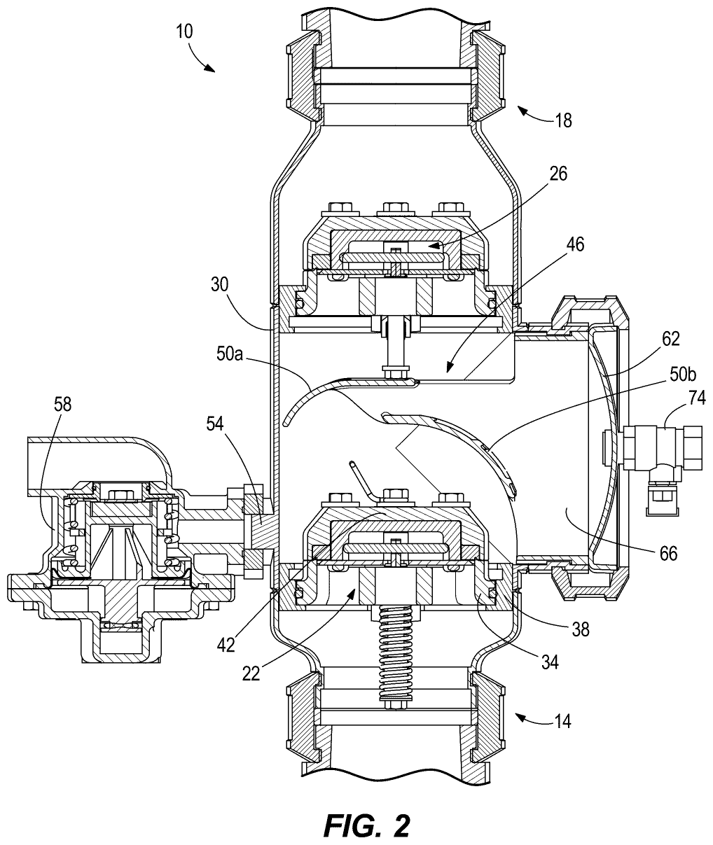

FIGS. 1 and 2 illustrate a backflow preventer 10 (e.g., a reduced pressure or RP backflow preventer) installed in a vertical orientation. The backflow preventer 10 includes an inlet 14 and an outlet 18. As shown in FIG. 2, the backflow preventer 10 may include a first check valve or upstream check valve 22 and a second check valve or downstream check valve 26. As used herein, the terms “upstream,” “downstream,” and variants thereof refer to the direction of flow from the inlet 14 to the outlet 18. The backflow preventer 10 includes a housing, coupling portion, or pipe 30 that houses the check valves 22, 26. As shown in FIG. 2, the seat or frame 34 of the check valves 22, 26 may be supported in the pipe 30 (e.g., by one or more mounts 38). The frame 34 may remain coupled to the mount 38 even when the valve body 42 (e.g., poppet, clapper, seal member, or moving member) of each check valve 22, 26 is removed.

The outlet 18 may be positioned in a stacked configuration relative to the inlet 14. In this context, a “stacked configuration” refers to a configuration in which the outlet is positioned substantially vertically above the inlet. The stacked configuration does not require that an axis of the outlet be aligned with an axis of the inlet (e.g., the outlet need not be coaxial with the inlet). For example, the outlet may be fully laterally offset from the inlet, or the outlet may be partially aligned such that an outer profile of the outlet overlaps with an outer profile of the inlet when viewed in a vertical direction. With that said, while coaxial alignment is not required, coaxial alignment of the outlet and the inlet would nonetheless provide a stacked configuration. In the embodiment illustrated in FIGS. 1 and 2, for example, the outlet 18 is coaxial with respect to the inlet 14 and is therefore also in a stacked configuration.

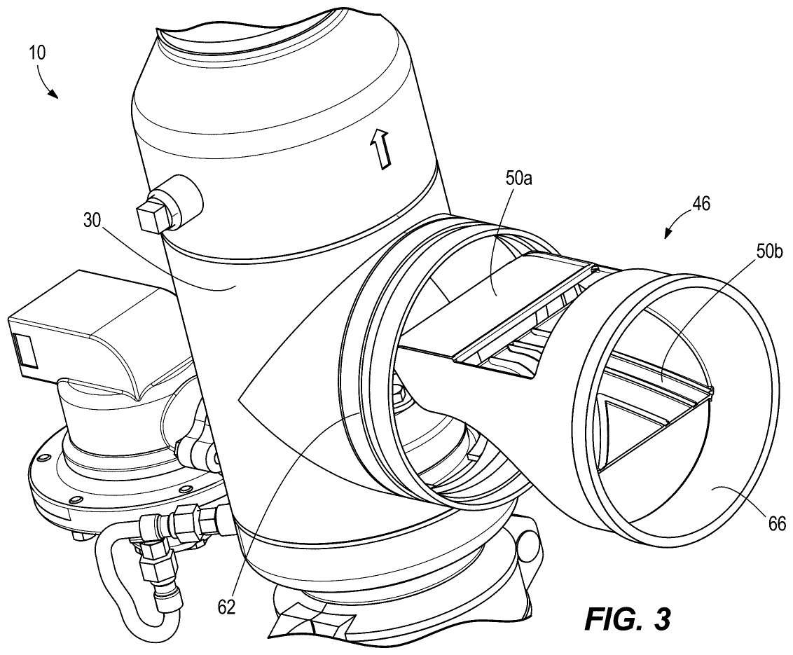

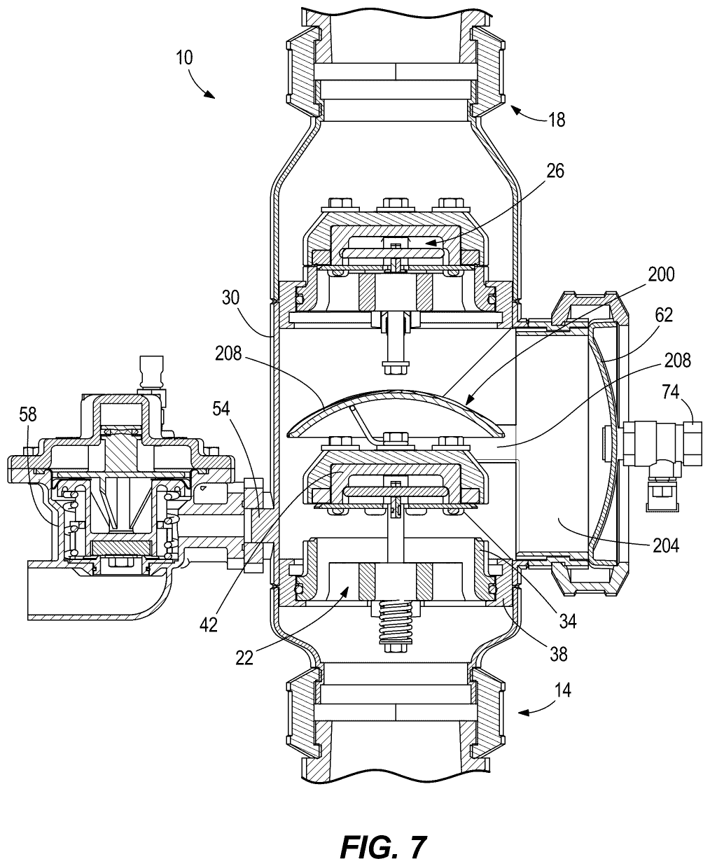

As shown in FIG. 2, an insert or diverter 46 may be positioned between the first upstream check valve 22 and second downstream check valve 26. The diverter 46 may include one or more obstructions 50 (e.g., guides, plates, covers, blocks, or baffles) positioned such that the obstructions or baffles 50 block or obstruct any backflow through the backflow preventer 10 from having a straight or clear path through the pipe 30 when the backflow preventer 10 is installed in a vertical orientation. Instead, the baffles 50 can direct any backflow fluid to the periphery or inner wall of the pipe 30. For example, as shown in FIGS. 2 and 3, the diverter 46 may include a first baffle 50a and a second baffle 50b. The first baffle 50a may be positioned above the second baffle 50b, and the first and second baffles 50a, 50b may at least partially overlap to prevent backflow leaking through a central portion or area of the diverter 46. The baffles 50a, 50b may also be shaped (e.g., angled or curved) to ensure any backflow fluid is directed to the periphery of the pipe (i.e., away from the central area). Thus, small amounts of backflow fluid can collect or accumulate around the frame 34 of the upstream check valve 22. Accumulated fluid around the frame 34 can be expelled via an opening or discharge port or discharge outlet 54 in the pipe 30. The discharge outlet 54 may be located at a lower end of the pipe 30 (see e.g., FIG. 7), and a lower opening portion of the discharge outlet 54 is positioned below an upper end of the frame 34 to ensure fluid can be expelled out of the discharge outlet 54 before pooling up over the frame 34. The discharge outlet 54 may be located anywhere on the circumference or exterior of the pipe 30, including located on an access port 62 or any other stovepipe, tec, or other fitting configuration extending from the pipe 30. A relief valve 58 may be coupled to the discharge outlet 54 to prevent fluid flow through the discharge outlet 54 when there is no backflow condition.

This configuration prevents backflow fluid from reaching the opening of the upstream valve 22 when the valve body 42 is removed so that any backflow fluid cannot flow upstream of the backflow preventer 10 and is instead discharged from the discharge outlet 54 and relief valve 58. This allows for removal of contaminants or hazardous water downstream of the backflow preventer 10 through the relief valve 58 while ensuring the contaminants or hazardous water do not leak upstream of the backflow preventer 10.

The pipe 30 may include an access port 62 (e.g., shown in a stovepipe configuration of the pipe 30 in the illustrated embodiments). When a cover of the access port 62 is removed, the check valves 22, 26 and other internal components of the backflow preventer 10 may be accessed by a user for testing or maintenance among other reasons. As shown in FIG. 3, the diverter 46 may be sized and shaped to be inserted through the access port 62. For example, as shown, the access port 62 may be round and the diverter 46 may have a cylindrical profile. As best shown in FIG. 2, the diverter 46 may include a base portion 66 that is received within the access port 62 when the diverter 46 is installed. The base portion 66 can engage the access port 62 to align and hold the diverter 46 in position during operation.

In some embodiments, the diverter 46 may be coupled or fixed to the cover of the access port 62, and the diverter 46 is removable and insertable with the cover (e.g., see diverter 400 in FIG. 13). In other embodiments, the diverter 46 may be coupled or fixed to another portion of the backflow preventer 10. For example, the diverter 46 may be welded, bolted, or otherwise securely attached to the pipe 30 or to a non-moving component of one of the check valves 22, 26, such as a seat of a check valve 22, 26.

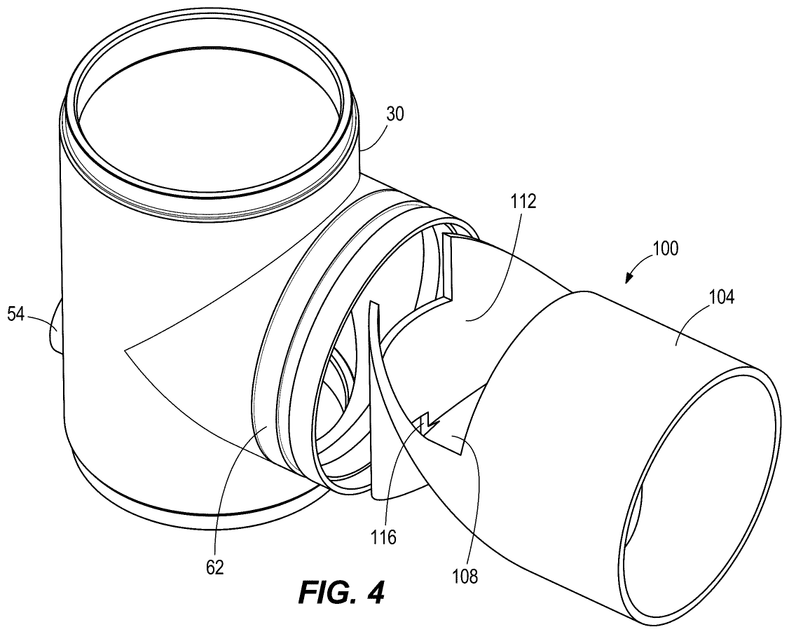

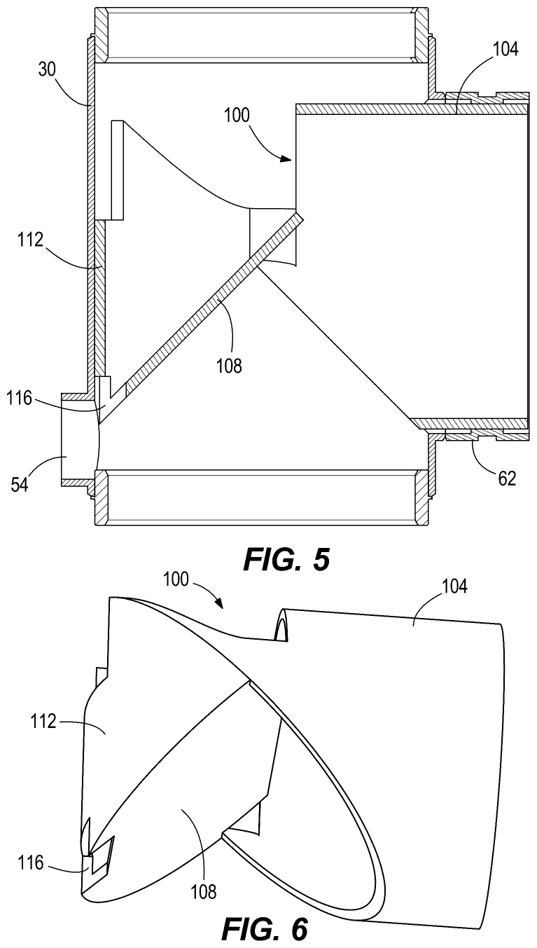

FIGS. 4-6 illustrate another embodiment of a diverter 100 that can be inserted or installed in the backflow preventer 10. The diverter 100 may include a base portion 104 that can be received in the access port 62. An upper end of the base portion 104 can also extend into the main body of the pipe 30 to obstruct flow through a portion of the pipe 30. A baffle 108 may overlap with the extended upper end of the base portion 104 such that any backflow is obstructed and directed to a periphery of the pipe 30. As shown in FIG. 5, the baffle 108 may be downwardly angled towards the discharge outlet 54 of the pipe 30. The angle of the baffle 108 and the amount of overlap between the baffle 108 and extended upper end can be selected to reduce pressure loss during normal fluid flow in the downstream direction. For example, the baffle 108 may be angled at approximately 45°.

The diverter 100 may also include an end wall 112 shaped to match the inside of the pipe 30. The baffle 108 and end wall 112 may join together to collect any backflow fluid that flows down the baffle 108. The diverter 100 may include a cutout or mouth 116 at a lower end of the baffle 108 and end wall 112 such that the accumulated backflow fluid can flow out of the mouth 116. As shown in FIG. 5, the mouth 116 may be aligned with the discharge outlet 54 to direct backflow fluid to the discharge outlet 54. The end wall 112 may have the shape of a portion of a cylinder to match the wall of the pipe 30. This also can have the effect of rotationally aligning the diverter 100 properly such that the mouth 116 is positioned adjacent the discharge outlet 54. If the diverter 100 is otherwise rotated about a central axis of the access port 62 as it is being inserted into the access port 62, the end wall 112 will contact the pipe 30 before the diverter 100 is fully inserted. Thus, the shape of the end wall 112 can force a user to properly orient the diverter 100 when installing and can keep the diverter 100 properly aligned during use.

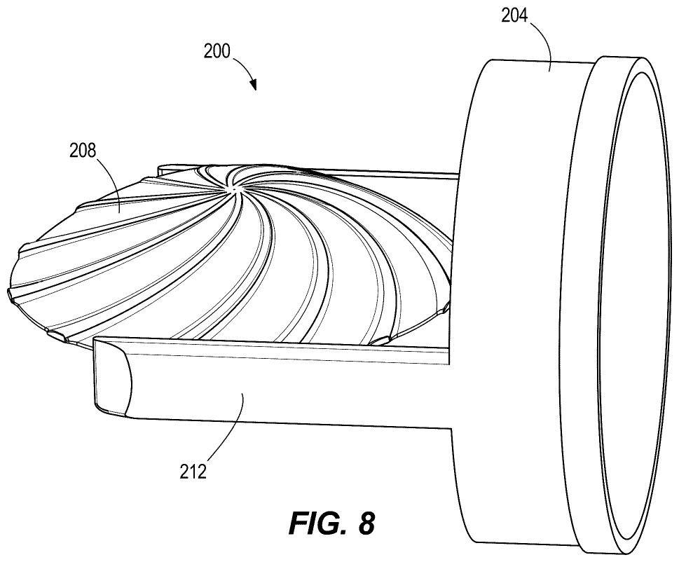

FIGS. 7 and 8 illustrate another embodiment of a diverter 200 that may be removably or fixedly positioned in the backflow preventer 10. The diverter 200 may include a base portion 204 that is insertable and removable through the access port 62. As shown, a central, domed cover or baffle 208 may be connected to the base portion 204 by arms 212 to hold the baffle 208 in position above the upstream check valve 22. In other embodiments, the central baffle 208 may be attached to other portions of the backflow preventer 10 to hold the central baffle 208 in position above the check valve 22 (e.g., via arms 212 or via direct attachment of the baffle 208 to other portions of the pipe 30 or check valve 22). The top side of the domed baffle 208 may have a convex shape to help guide any backflow fluid to a periphery of the pipe 30 to be expelled out of the discharge outlet 54. The bottom side of the baffle 208 may have a concave shape or recess, and the valve body 42 may partially extend into or toward the recess when the upstream check valve 22 opens, minimizing disruption or interference with fluid flow in the desired downstream direction.

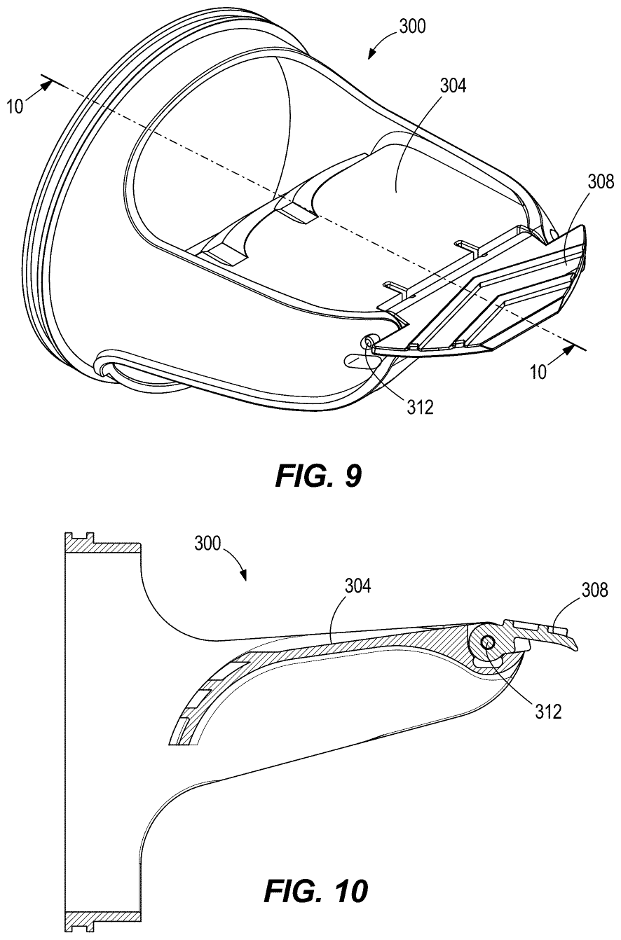

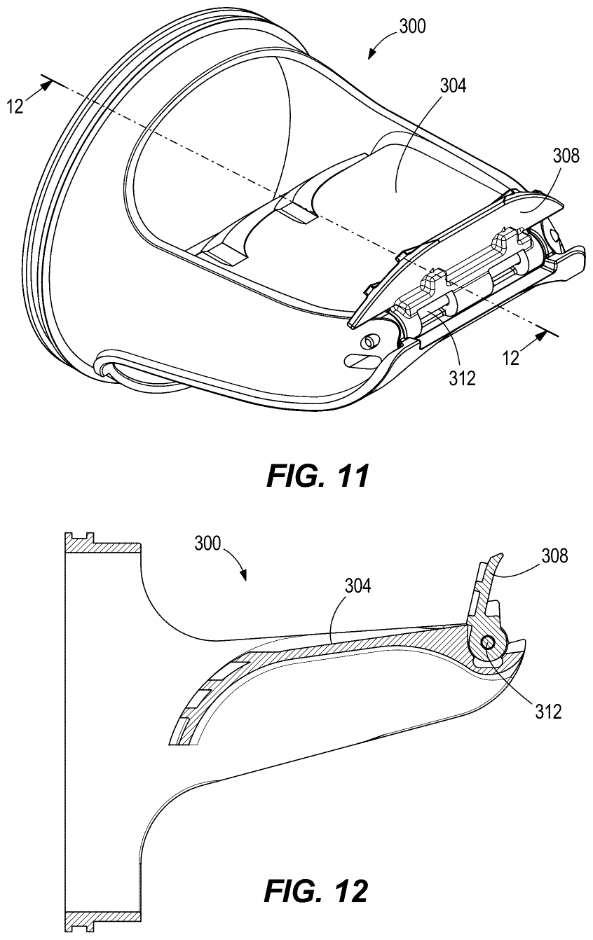

FIGS. 9-12 illustrate another embodiment of an obstruction or diverter 300 that may be removably or fixedly positioned in the backflow preventer 10. The diverter 300 may include a fixed baffle 304 and a movable flap or movable baffle 308. As shown in FIGS. 9 and 10, the movable baffle 308 may be configured in a closed position to further obstruct backflow fluid along with the fixed baffle 304. As shown in FIGS. 11 and 12, the movable baffle 308 may be configured in an open position that provides additional area and paths for downstream fluid flow. In the exemplary embodiment, the movable baffle 308 pivots or rotates about a hinge or axis or pivot member 312. In other embodiments, the movable baffle 308 may be biased to move vertically, laterally, or a combined vertical, lateral, and/or rotational movement between the open and closed positions.

The movable baffle 308 may be configured to move between the closed position (FIGS. 9 and 10) and the open position (FIGS. 11 and 12) depending on the presence or absence of downstream fluid flow. For example, the movable baffle 308 may be biased to pivot to the open position by the pressure of downstream fluid flow. In the absence of downstream fluid flow, the movable baffle 308 may return to the closed position. The movable baffle 308 may be biased to return to the closed position by the weight of the movable baffle 308 or by a biasing mechanism, such as a spring. For example, a torsion spring (not shown) may be positioned on the pivot member 312 to bias the movable baffle 308 to the closed position unless a sufficient pressure or force of downstream fluid flow moves it to the open position. With the movable baffle 308 in the open position, the pressure drop associated with flowing around the diverter 300 may be reduced. The exemplary embodiment is shown with a single movable baffle 308. In other embodiments, the diverter 300 may include a plurality of movable baffles 308.

FIG. 13 illustrates another embodiment of a diverter 400. The diverter 400 is similar to diverter 300 shown in FIGS. 9-12. The diverter 400 is integrally formed with a cover 404 for an access port or the like such that the diverter 400 may be attached or removed with the cover 404.

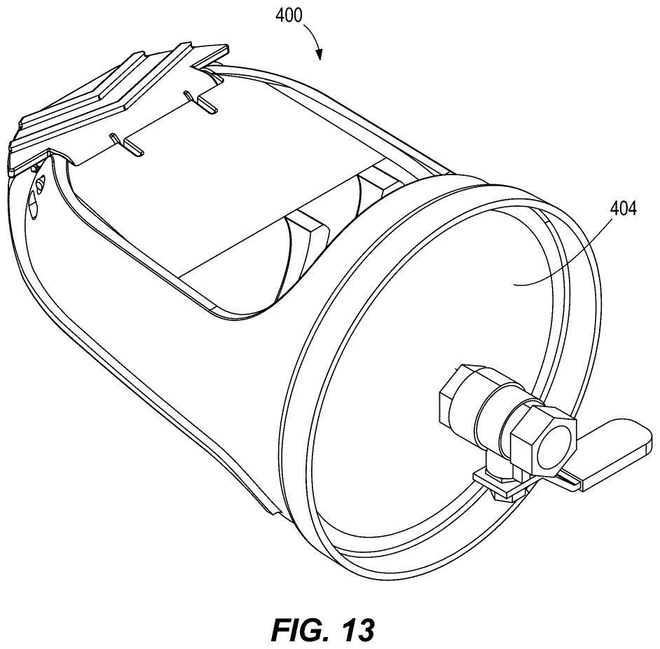

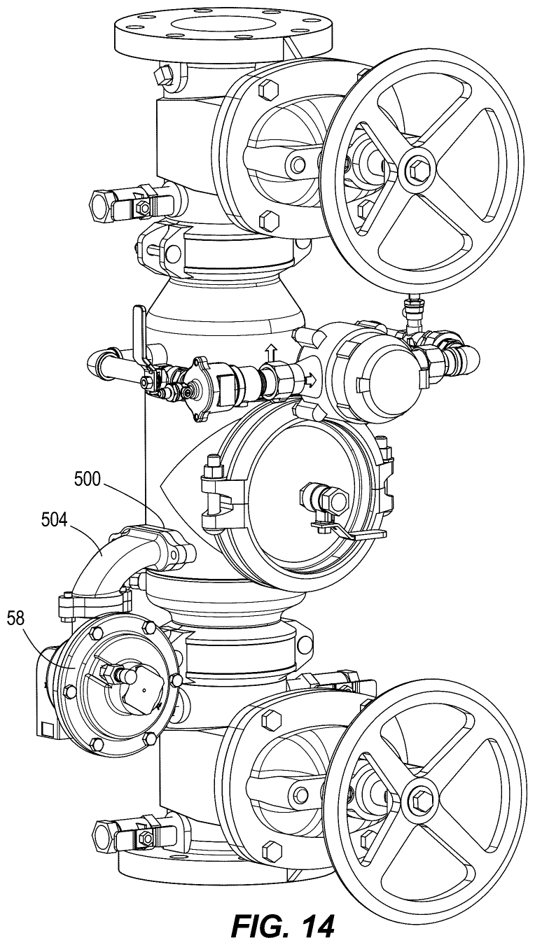

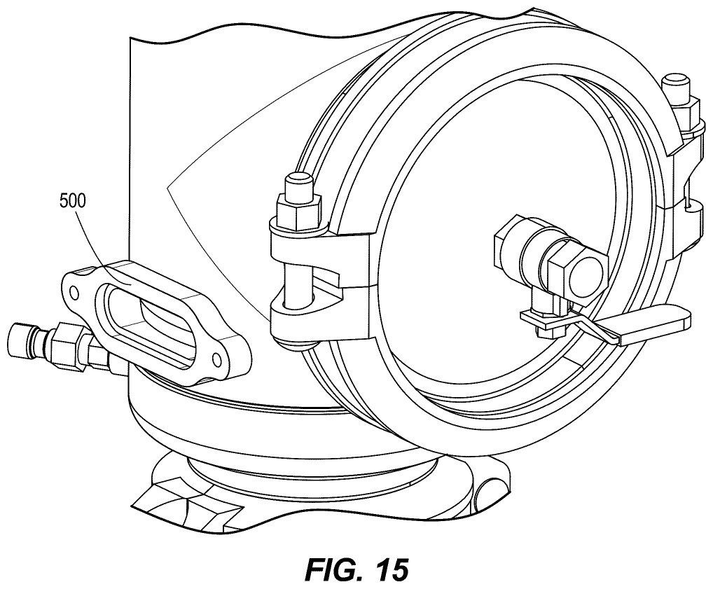

FIGS. 14 and 15 illustrate a discharge outlet 500 for expelling fluid. The discharge outlet 500 has a different shape than discharge outlet 54 shown in FIG. 7. Discharge outlet 500 may be elongated horizontally or have a larger horizontal dimension than its vertical dimension (e.g., having an elliptical or oval shape). The elongated discharge outlet 500 can maximize the flow area positioned below the upper end of the frame 34 of the lower check valve 22 (see FIG. 7) to prevent fluid from accumulating such that the fluid rises or pools up over the upper end of the frame 34. The elongated discharge outlet 500 may also minimize the amount of standing fluid below the upper end of the frame 34 once fluid flow stops. As shown in FIG. 14, an adapter 504 may couple the relief valve 58 to the discharge outlet 500. The adapter 504 may smoothly transition from the elongated opening of the discharge outlet 500 at one end to a circular opening at the other end for coupling to a relief valve 58 with a standard connection. The adapter 504 may include an elbow or bend to orient the relief valve 58 in a desired position relative to the discharge outlet 500.

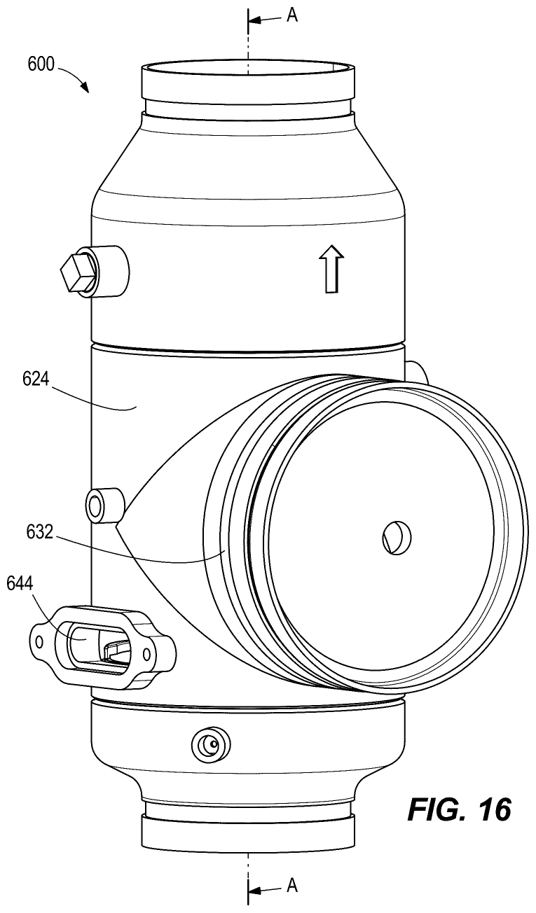

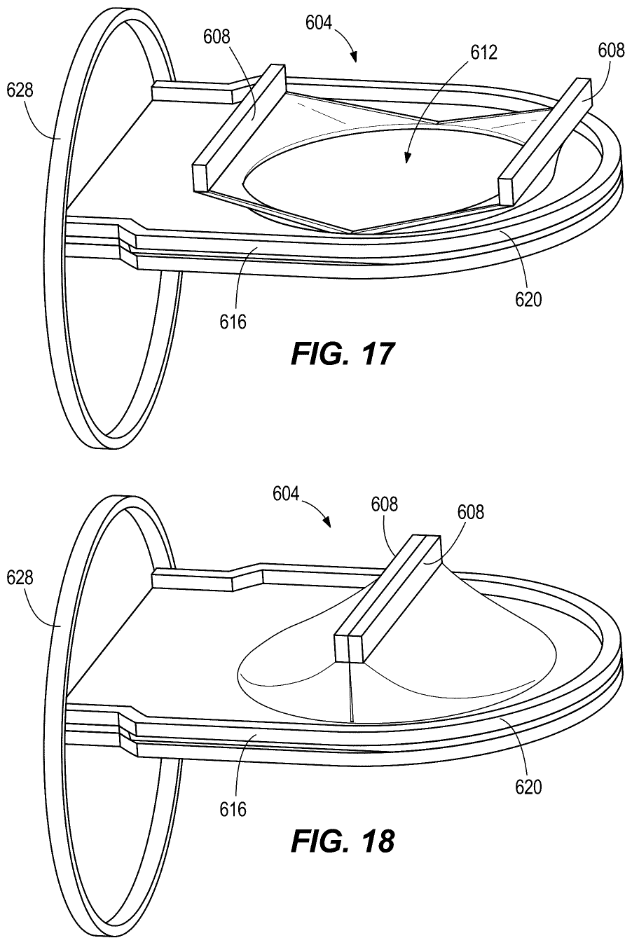

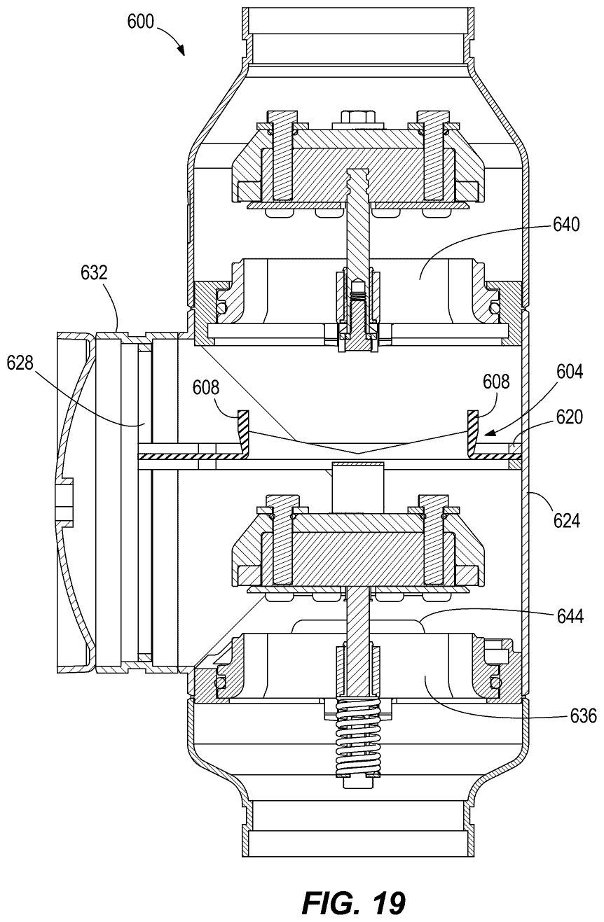

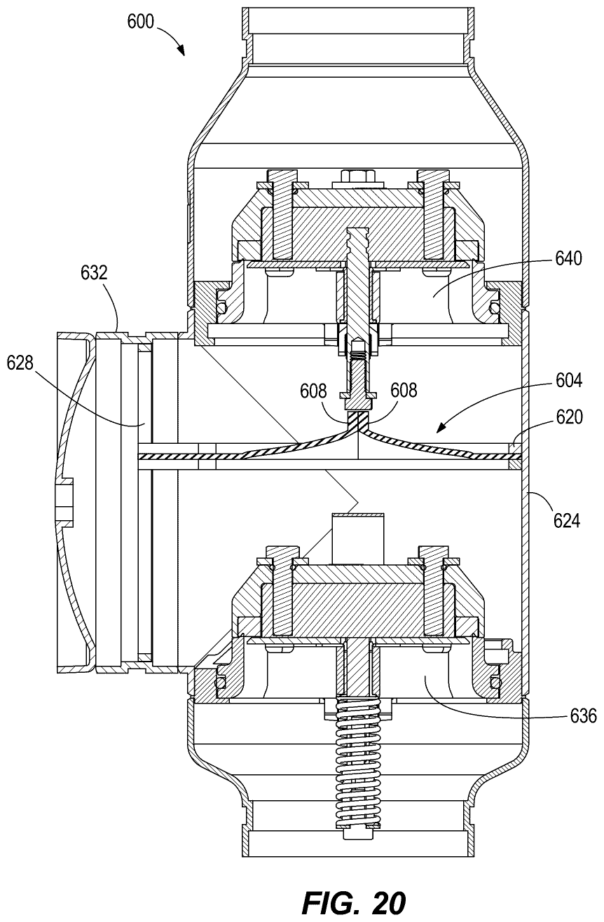

FIGS. 16-20 illustrate a backflow preventer 600 including another embodiment of an obstruction or diverter 604. The diverter 604 may include an elastic-type, flexible. or deformable material (e.g., rubber) that can be biased by fluid flow pressure. The flexible material may be configured in an unbiased state such that the flexible material prevents fluid flow through an area of the diverter 604 and may be configured to be biased by downstream fluid flow or fluid pressure to manipulate the flexible material to “open” or provide additional flow pathways for the downstream fluid flow. For example, as shown, the flexible material may be arranged or configured as a “duckbill,” which may include opposing sidewalls or flaps 608 that are biased together or seal together in a closed configuration (FIGS. 18 and 20) and that can be biased apart to form a central opening 612 in an open configuration (FIGS. 17 and 19). Downstream fluid flow can bias the flaps 608 open and allow fluid flow to pass through the central opening 612. When downstream fluid flow is not present, the flaps 608 are biased to return to the closed configuration. The flaps 608 may be angled such that backflow fluid is diverted off of the flaps 608 and does not bias the flaps 608 to separate or open, thereby diverting backflow fluid to a periphery of the diverter 604.

As best shown in FIGS. 17 and 18, the diverter 604 may include a rigid frame 616, which can mount the diverter 604 in the backflow preventer 600. The frame 616 may include a first portion 620 that attaches to the flexible material and can help keep the shape of the flexible material. As shown, the first portion 620 may also be generally shaped to correspond to an interior profile or cross-section of the flow conduit or pipe 624 of the backflow preventer 600. The frame 616 may also include a second portion 628, which can help a user to insert and orient the diverter 604 in instances where the diverter 604 may be removable. As shown, the second portion 628 is configured to mount in the access port or stovepipe 632 of the backflow preventer 600. As shown in FIGS. 19 and 20, the diverter 604 may be positioned between the upstream check valve 636 and downstream check valve 640. The diverter 604 may be configured and positioned to divert backflow fluid away from an opening of the upstream check valve 636 and instead diverted to a periphery where any accumulated backflow fluid can drain through a discharge port 644.

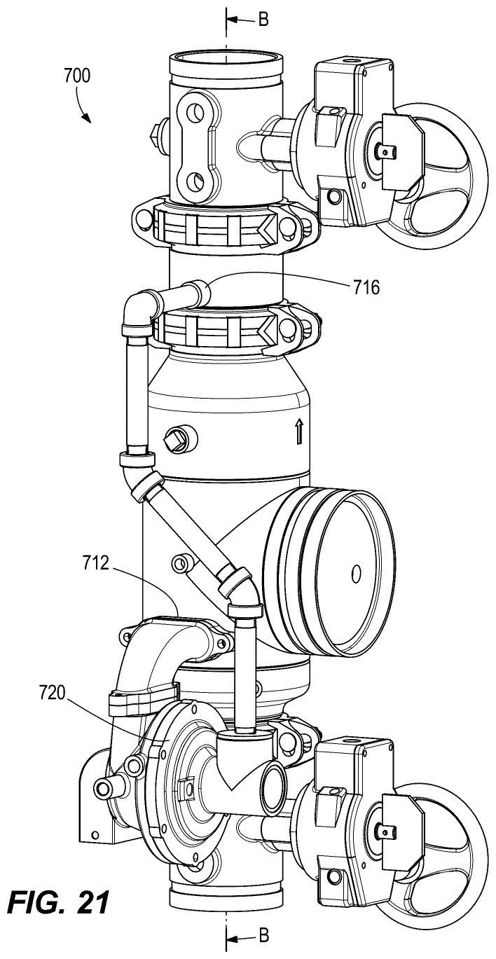

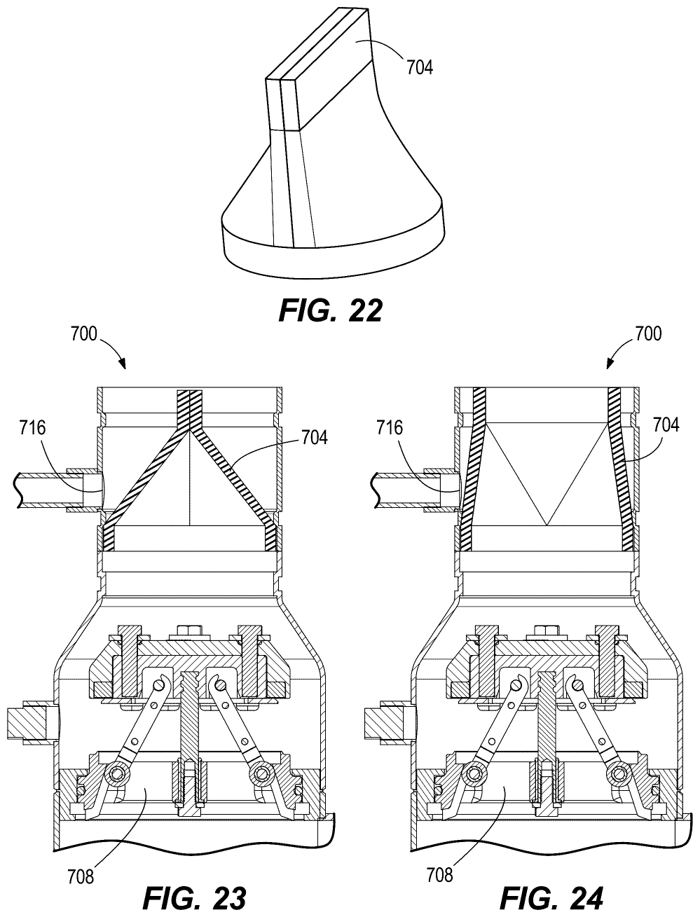

FIGS. 21-24 illustrate another embodiment of a backflow preventer 700. The backflow preventer 700 may include an obstruction or diverter 704 that operates similarly to the diverter 604 described in FIGS. 16-20. The backflow preventer 700 may include an upstream check valve (not shown) and a downstream check valve 708, and the diverter 704 may be positioned downstream of the downstream check valve 708. The backflow preventer 700 may include an upstream discharge port 712 (FIG. 21) that is positioned between the upstream check valve and the downstream check valve 708 similar to discharge port 644 in FIGS. 16-20, for example. The backflow preventer 700 may also include a downstream discharge port 716 positioned downstream of the diverter 704. As shown, the diverter 704 may be a “duckbill” that can be biased to an open configuration (FIG. 23) by downstream fluid flow or pressure and that is otherwise biased to return to a closed configuration (FIG. 24) in the absence of downstream fluid flow. When the diverter 704 is in a closed configuration, the diverter 704 may block backflow fluid from passing the diverter 704, and instead, the backflow fluid may be directed to the downstream discharge port 716.

As shown in FIG. 21, the upstream discharge port 712 and downstream discharge port 716 may both tie into or discharge fluid to a single relief valve 720. In other embodiments, the upstream discharge port 712 and downstream discharge port may each be coupled to separate relief valves.

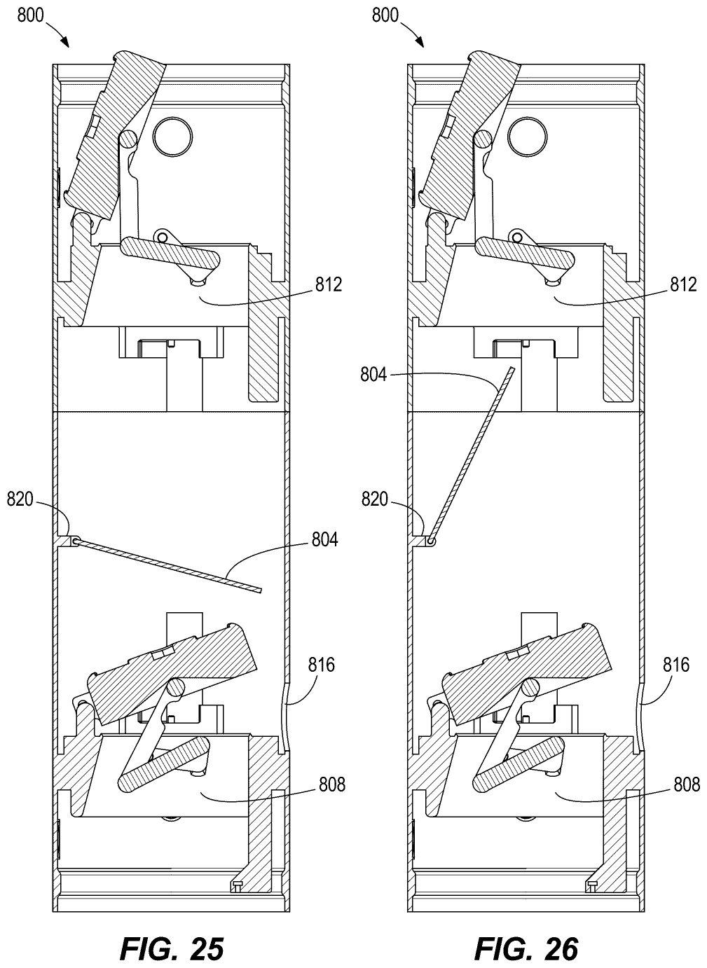

FIGS. 25 and 26 illustrate another embodiment of a backflow preventer 800 (illustrated as section views similar to the section views shown of backflow preventer 600 in FIGS. 19 and 20) including another embodiment of an obstruction or diverter 804. The diverter 804 may be a paddle, disc, or flap positioned between the upstream check valve 808 and the downstream check valve 812. As shown in FIG. 25, the diverter 804 may be configured to obstruct, block, or divert backflow fluid from passing through the upstream check valve 808 and instead divert the fluid to a periphery to ultimately flow out of discharge port 816. As shown in FIG. 26, the diverter 804 may be hinged or pivot or rotate about a pivot member 820 such that downstream fluid flow biases the diverter 804 to a less obstructive position for downstream fluid flow, which can reduce the associated pressure drop during a downstream fluid flow condition. When there is no downstream fluid flow, the diverter 804 may be biased to return to the “diverting” position by the weight of the diverter 804 or by a biasing mechanism, such as a spring. In other embodiments, the diverter 804 may be made of a flexible material, which can flex or pivot upwards at a distal end opposite the mounting point of the diverter 804. In some embodiments, the diverter 804 may be rotatable and be made of a flexible material.

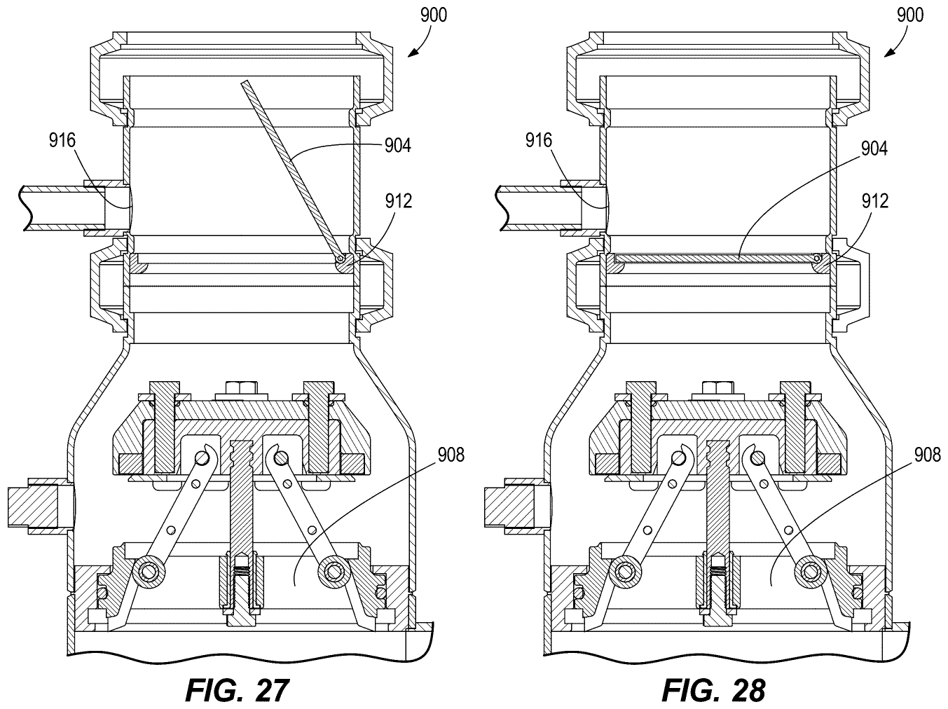

FIGS. 27 and 28 illustrate another embodiment of a backflow preventer 900 (illustrated as section views similar to the section views shown of backflow preventer 700 in FIGS. 23 and 24) including an obstruction or diverter 904 that operates similarly to the diverter 804 described in FIGS. 25 and 26. The backflow preventer 900 may include an upstream check valve (not shown) and a downstream check valve 908, and the diverter 904 may be positioned downstream of the downstream check valve 908. The diverter 904 may pivot open (FIG. 27) about a pivot member 912 to allow downstream fluid flow to flow past the diverter 904 with less obstruction. In the absence of downstream fluid flow, the diverter 904 may pivot or fall to a closed or sealed position (FIG. 28) preventing backflow fluid from passing through the downstream check valve 908. Instead, backflow fluid may accumulate and be diverted via a discharge port 916 positioned upstream of the diverter 904.

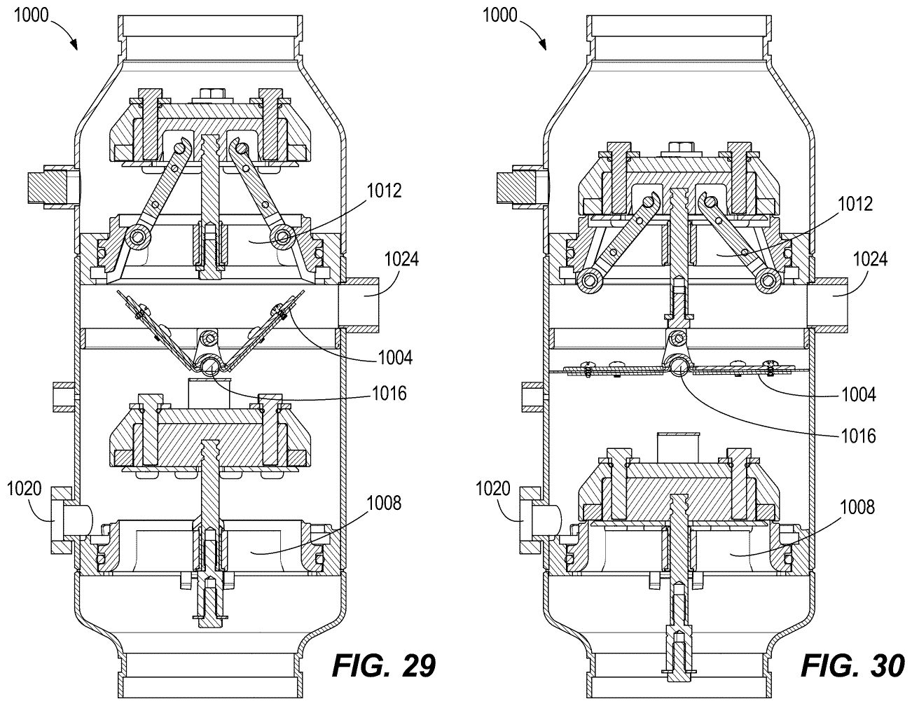

FIGS. 29 and 30 illustrate another embodiment of a backflow preventer 1000 (illustrated as section views similar to the section views shown of backflow preventer 600 in FIGS. 19 and 20) including another embodiment of an obstruction or diverter 1004 positioned between an upstream check valve 1008 and a downstream check valve 1012. The diverter 1004 may include two plates hinged or pivotable about a pivot member 1016 to pivot between an open configuration (FIG. 29) and a closed configuration (FIG. 30). Put another way, the diverter 1004 may be a “butterfly” style device. In some embodiments, the diverter 1004 diverts backflow fluid away from passing through the upstream check valve 1008 and diverts the fluid to an upstream discharge port 1020. In some embodiments, as shown in FIG. 30, the diverter 1004 can close or seal against the sidewall or other portion of the backflow preventer 1000, and backflow fluid accumulating on the diverter 1004 can be diverted to downstream discharge port 1024.

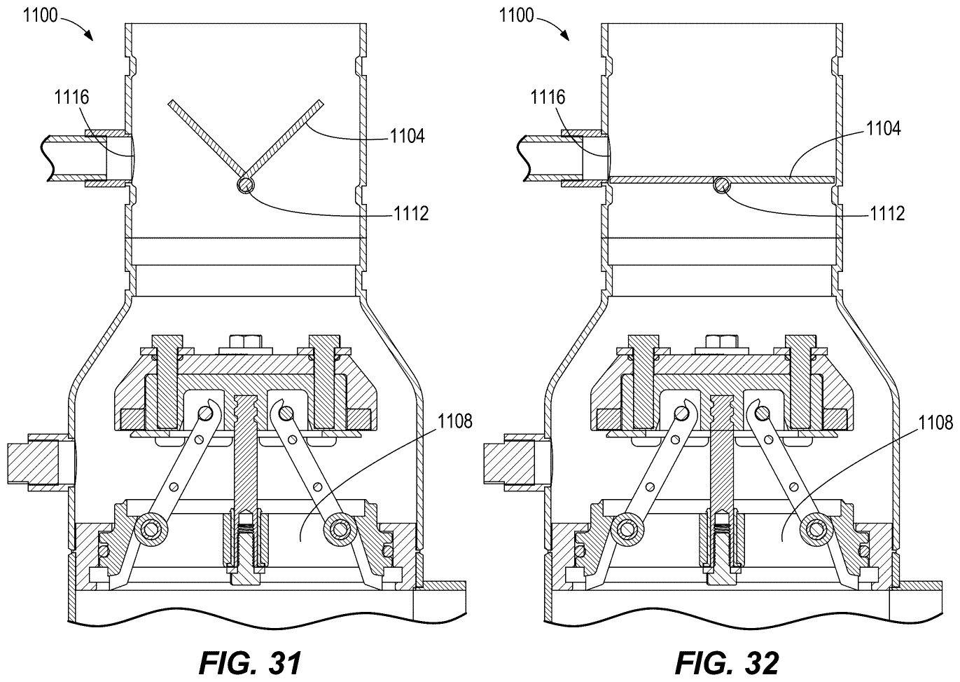

FIGS. 31 and 32 illustrate another embodiment of a backflow preventer 1100 (illustrated as section views similar to the section views shown of backflow preventer 700 in FIGS. 23 and 24) including an obstruction or diverter 1104 that operates similarly to the diverter 1004 described in FIGS. 29 and 30. The backflow preventer 1100 may include an upstream check valve (not shown) and a downstream check valve 1108, and the diverter 1104 may be positioned downstream of the downstream check valve 1108. The “butterfly” style diverter 1104 may pivot open (FIG. 31) about a pivot member 1112 to allow downstream fluid flow to flow past the diverter 1104 with less obstruction. In the absence of downstream fluid flow, the diverter 1104 may pivot or fall to a closed or sealed position (FIG. 32) preventing backflow fluid from passing through the downstream check valve 1108. Instead, backflow fluid may accumulate and be diverted via a discharge port 1116 positioned upstream of the diverter 1104.

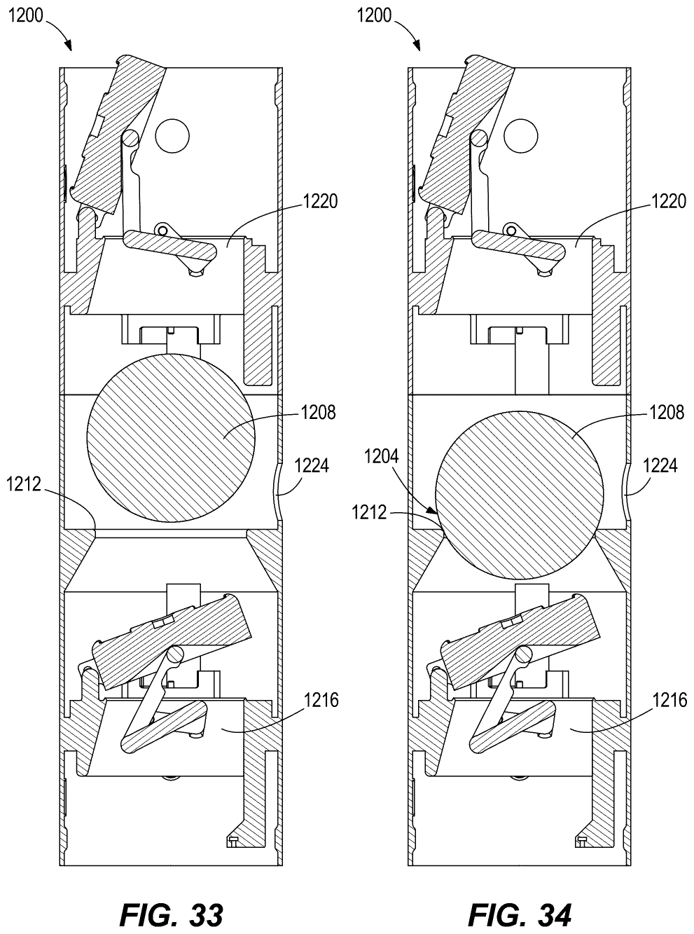

FIGS. 33 and 34 illustrate another embodiment of a backflow preventer 1200 (illustrated as section views similar to the section views shown of backflow preventer 600 in FIGS. 19 and 20) including another embodiment of an obstruction or diverter 1204. The diverter 1204 may include a buoyant or floating member 1208 and a frame or seat 1212 positioned between the upstream check valve 1216 and the downstream check valve 1220. As shown in FIG. 33, downstream fluid flow pressure, or the buoyancy of the floating member 1208, may move the floating member 1208 away from the seat 1212 to provide a flow path through an opening in the seat 1212. In the absence of downstream fluid flow, the floating member 1208 may settle or drop to mate or seal against the seat 1212 to obstruct or block backflow fluid from passing through the upstream check valve 1216 and instead divert the fluid flow out of discharge port 1224.

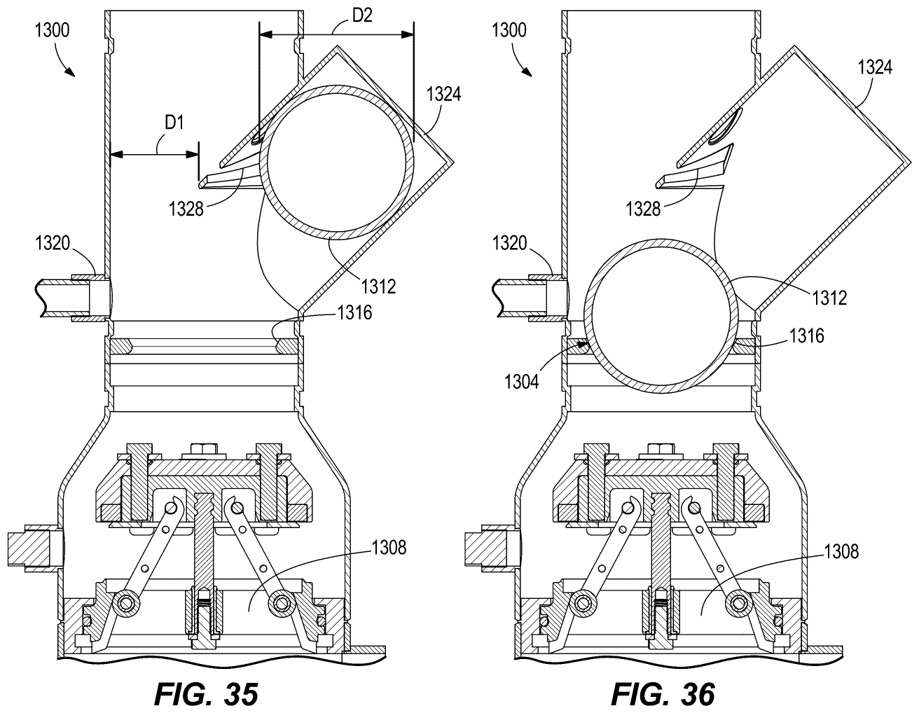

As shown in the illustrated embodiment, the floating member 1208 may be a ball or sphere and the seat 1212 may have a circular opening that corresponds to a cross-section of the ball. The round shape of the floating member 1208 can help align the floating member 1208 to properly seal against the seat 1212 as it drops. In some embodiments, the floating member 1208 (and seat 1212) may have other geometries, such as a cone. As shown in FIG. 33, the floating member 1208 may float upwards and downstream fluid flow may pass around the floating member 1208. In other embodiments, the backflow preventer may include a receptacle for the floating member 1208 to move into during downstream flow conditions similar to the diverted receptacle 1324 shown in FIGS. 35 and 36.

FIGS. 35 and 36 illustrate another embodiment of a backflow preventer 1300 (illustrated as section views similar to the section views shown of backflow preventer 700 in FIGS. 23 and 24) including an obstruction or diverter 1304 that operates similarly to the diverter 1204 described in FIGS. 33 and 34. The backflow preventer 1300 may include an upstream check valve (not shown) and a downstream check valve 1308, and the diverter 1304 may be positioned downstream of the downstream check valve 1308. The diverter 1304 may include a floating member 1312 and a frame or seat 1316 configured for the floating member to mate or seal against when there is no downstream flow condition (FIG. 36). Instead, backflow fluid may accumulate and be diverted via a discharge port 1320.

The backflow preventer 1300 may include an angled stovepipe, Y-branch, or diverted receptacle 1324 that can receive the floating member 1312 during conditions of downstream flow (FIG. 35). This can provide a more direct flow path and reduce pressure loss of the downstream flow. An end portion of the diverted receptacle 1324 or other obstructions in the main flow path may be positioned a distance D1 from the sidewall opposite the diverted receptacle 1324. The distance D1 may be less than a width D2 of the floating member 1312 such that the floating member 1312 is prevented from bypassing the diverted receptacle 1324. Portions of the sidewalls of the diverted receptacle may also include cutouts or openings 1328 to provide additional flow paths and reduce pressure loss associated with the diverted receptacle 1324.

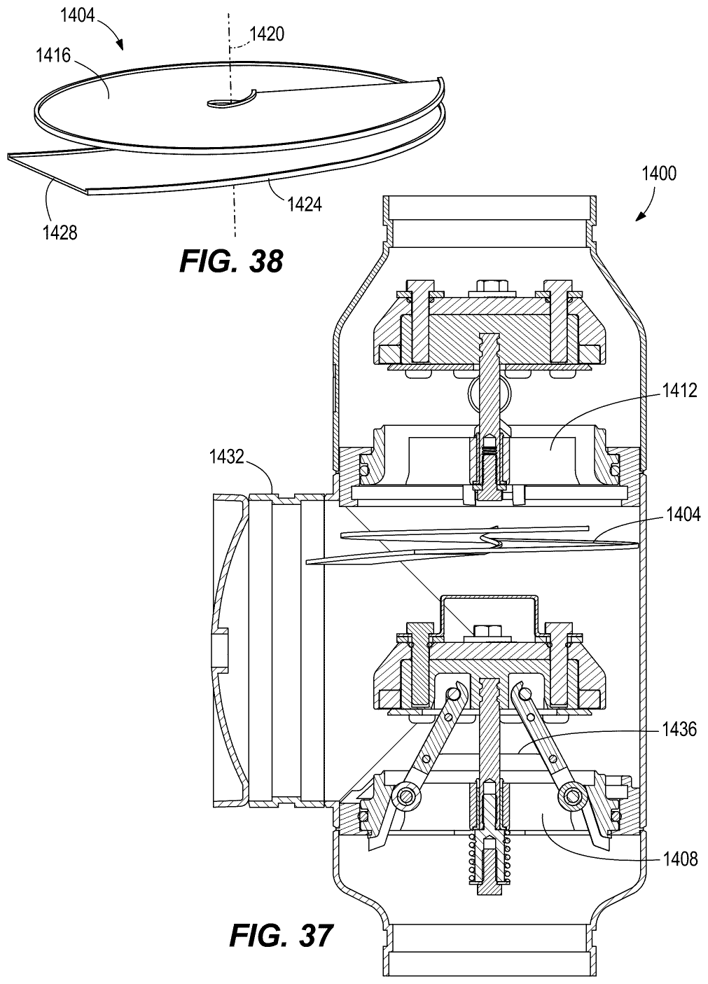

FIG. 37 illustrates another embodiment of a backflow preventer 1400 (illustrated as a section view similar to the section views shown of backflow preventer 600 in FIGS. 19 and 20) including another embodiment of an obstruction or diverter 1404 (FIG. 38) positioned between an upstream check valve 1408 and a downstream check valve 1412. The diverter 1404 may include a helical strip or helical panel 1416 wrapped or wound around an axis 1420 such that it blocks backflow fluid from passing through an opening of the upstream check valve 1408. Instead, backflow fluid may be carried along the spiraling or helical path of the helical panel 1416 (downstream fluid flow may flow in an opposite helical direction and/or around the edges of the helical panel 1416 to pass through and around the diverter 1404). The helical panel 1416 may include vertical barriers or walls 1424 at its side edges to prevent backflow fluid from spilling off of the edges and to instead funnel the backflow fluid toward a backflow discharge end or distal end 1428 of the helical panel 1416. In some embodiments, the helical panel 1416 may have a curved or angled cross-section (“U”-shaped or “V”-shaped) to help keep backflow fluid on the helical panel 1416 until it reaches the distal end 1428. The distal end 1428 may be positioned to divert backflow fluid away from the opening of the upstream check valve 1408. For example, it may be diverted to the stovepipe portion 1432 as shown in FIG. 37, may be diverted to the periphery generally, or may be diverted directly towards the discharge port 1436.

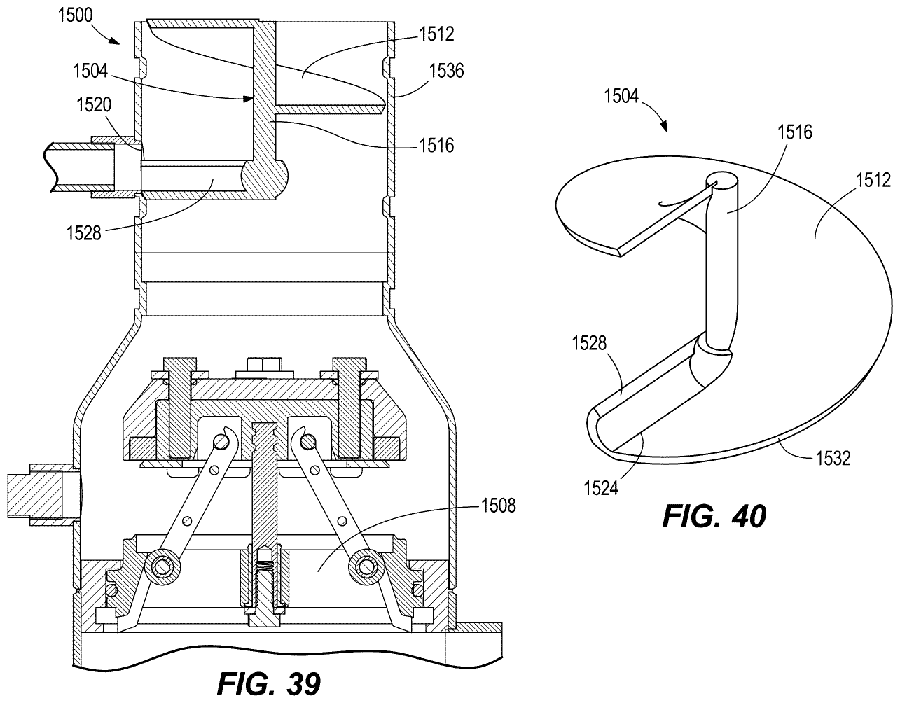

FIG. 39 illustrates another embodiment of a backflow preventer 1500 (illustrated as a section view similar to the section views shown of backflow preventer 700 in FIGS. 23 and 24) including an obstruction or diverter 1504 (FIG. 40) that operates similarly to the diverter 1404 described in FIGS. 37 and 38. The backflow preventer 1500 may include an upstream check valve (not shown) and a downstream check valve 1508, and the diverter 1504 may be positioned downstream of the downstream check valve 1508. The diverter 1504 may include a helical strip or helical panel 1512 wrapped or wound around an axis or post 1516 such that it blocks backflow fluid from passing through an opening in the downstream check valve 1508. Instead, backflow fluid may be carried along the spiraling or helical path of the helical panel 1512 to a discharge port 1520. An upstream end or discharge end 1524 of the helical panel 1512 may include a wall or flow barrier 1528 to prevent backflow fluid from continuing down past the diverter 1504 and instead directing the backflow fluid toward the discharge port 1520. The perimeter edges 1532 of the helical panel 1512 may be configured to seal against the interior sidewall 1536 of the backflow preventer 1500. In some embodiments, such as embodiments where the diverter 1504 is removable, the perimeter edges 1532 may include a flexible or rubber-like material to help ensure a seal between the perimeter edges 1532 and interior sidewall 1536.

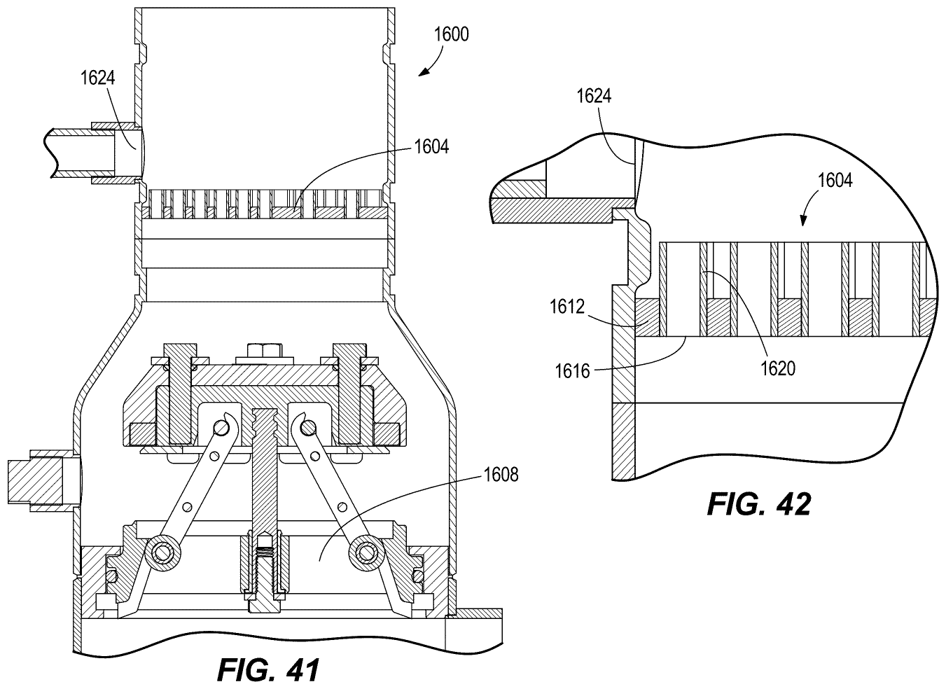

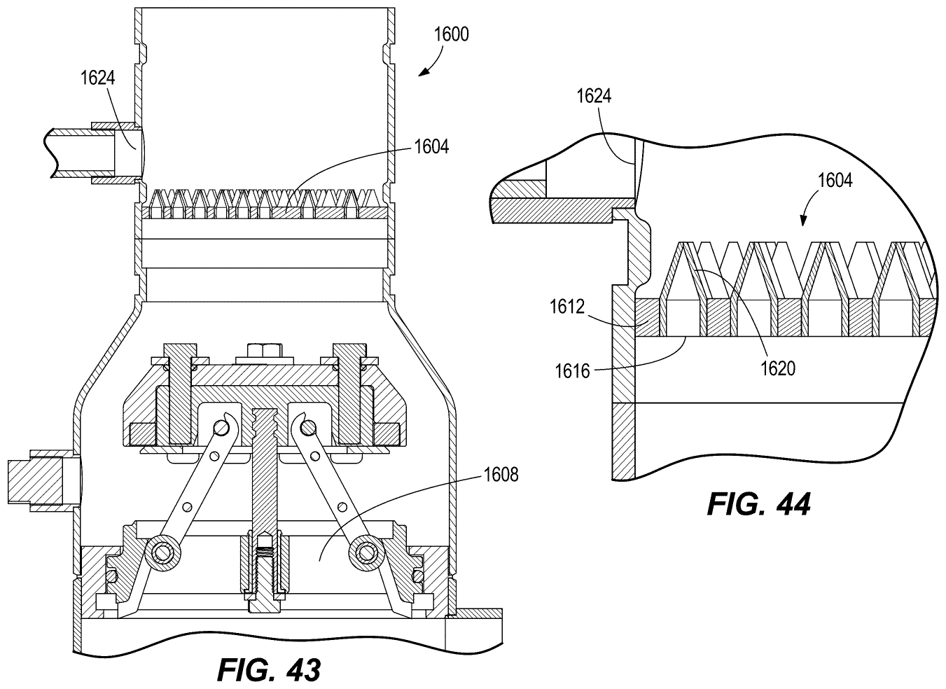

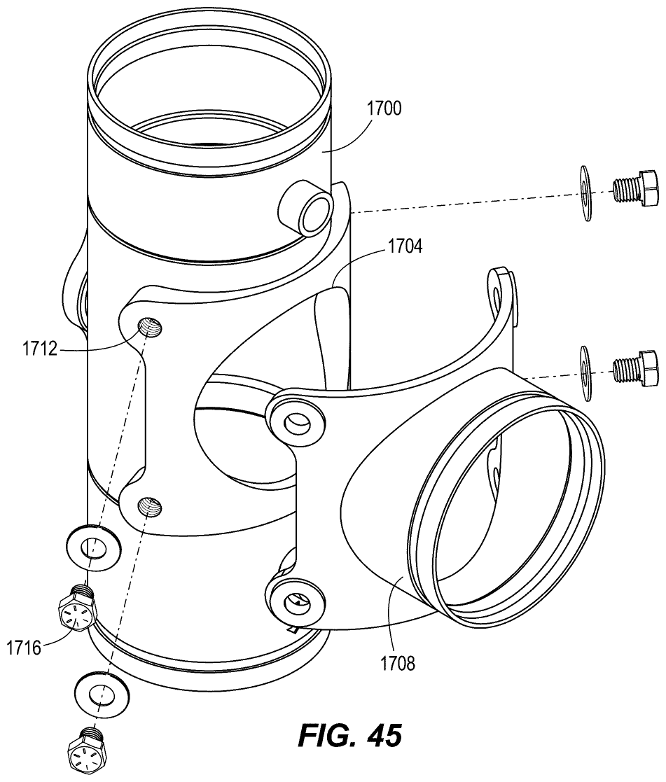

FIGS. 41-44 illustrate another embodiment of a backflow preventer 1600 (illustrated as section views similar to the section views shown of backflow preventer 700 in FIGS. 23 and 24) including an obstruction or diverter 1604 according to another embodiment. The backflow preventer 1600 may include an upstream check valve (not shown) and a downstream check valve 1608, and the diverter 1604 may be positioned downstream of the downstream check valve 1608. The diverter 1604 may include a plate 1612 with a plurality of holes 1616 (as best shown in FIGS. 42 and 44) for allowing fluid to flow through the plate 1612. Each hole 1616 may include a nozzle 1620 that allows fluid to flow through the nozzle 1620 in a downstream direction but that prohibits fluid flowing in an upstream direction. As shown in the illustrated embodiment, the nozzles 1620 may be configured to be closed to fluid flow (as shown by closed tips in FIG. 44) during no flow conditions or during backflow conditions. The nozzles 1620 may be biased by downstream fluid flow or pressure to open (as shown by opened tips in FIG. 42) and allow downstream fluid to flow through. For example, the nozzles 1620 may be rubber or a similar flexible material that can be forced open via internal pressure inside the nozzle 1620. During backflow conditions, backflow fluid may accumulate on the plate 1612 and discharge via discharge port 1624. In some embodiments, the diverter 1604 may be located between the upstream check valve and downstream check valve 1608.

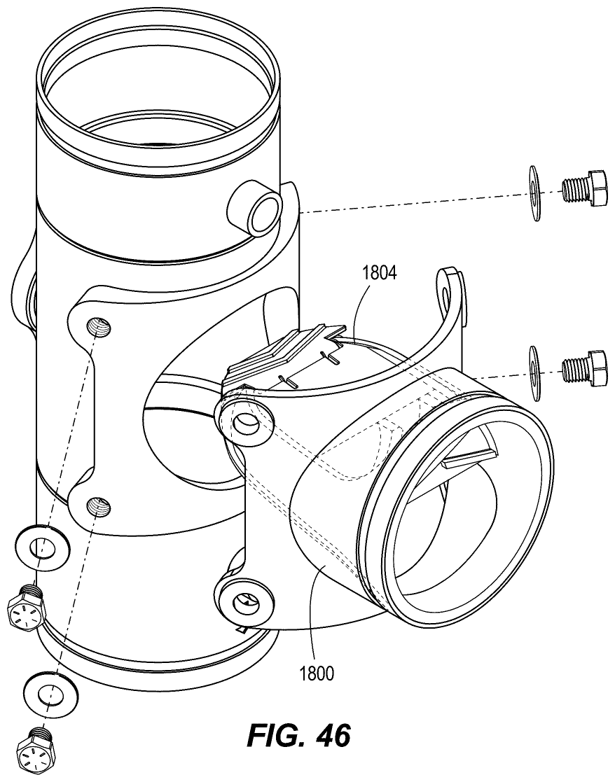

FIG. 45 illustrates a coupling or pipe 1700 for a backflow preventer. The pipe 1700 may include an access port 1704. A removable stovepipe or extension 1708 may be coupled or fastened to the access port 1704. In some cases, the extension 1708 may replace a flat cover for the access port 1704 and may use the same bolt holes 1712 for the flat cover to fasten the extension 1708 to the pipe 1700 using fasteners 1716. The extension 1708 can provide additional space to insert a diverter (similar to any of the diverters illustrated in the several embodiments in FIGS. 1-44) or for fluid to flow around a diverter. In some embodiments, as shown if FIG. 46, a removable stovepipe or extension 1800 may include a diverter 1804 fixedly mounted to the extension 1800.

As shown in FIG. 1, the backflow preventer 10 may include shutoff valves 70, such as gate valves, globe valves, ball valves or other types of shutoff or flow control valves at the inlet 14 and outlet 18. The backflow preventer 10 may include couplings, connections, valves, or fittings 74, such as NPT fittings or quick-connect fittings. The fittings 74 may be used to install gauges, such as flow or pressure gauges, during use or to connect compressed air or other fluid sources to assist with cleaning, maintenance, or testing.

A backflow preventer is expected to prevent fluid flow into the inlet during a backflow condition, and inhibiting fluid flow into the inlet can be difficult in a stacked configuration. Indeed, certification requirements for a vertical up backflow preventer may require removal of check valve bodies during testing, while still requiring that the backflow preventer prevents fluid leakage through the void or opening of the upstream check valve with the backflow preventer in its installed position. Backflow preventers typically are not installed vertically and can occupy a significant footprint. Moreover, retrofitting or installing new backflow preventers that comply with the testing standards in existing plumbing stacks can be logistically challenging or impossible without significant changes to the existing plumbing stack. The backflow preventer 10 is compact while also preventing any backflow from a downstream portion through the upstream check valve 22, even when the upstream check valve 22 is not present.

It will be understood that certain features and sub combinations are of utility and may be employed without reference to other features and sub combinations. Features described and illustrated with respect to certain embodiments may also be implemented in other embodiments. This is contemplated by and is within the scope of the claims. Since other possible embodiments of the disclosure may be made without departing from the scope thereof, it is understood that examples herein described or shown in the accompanying drawings are to be interpreted as illustrative and are not intended to limit the concepts and principles of the present disclosure. Many changes, modifications, variations and other uses and applications of the illustrated examples will become apparent to those skilled in the art after considering the specification and the accompanying drawings. Such changes, modifications, variations and other uses and applications are deemed to be covered by the disclosure.

What is claimed is:

1. A backflow preventer comprising:
an inlet;
an outlet positioned in a stacked configuration with respect to the inlet, the outlet positioned downstream of the inlet with respect to a flow path in which fluid flows from the inlet to the outlet;
a first check valve located between the inlet and the outlet with respect to the flow path;
a second check valve located between the first check valve and the outlet with respect to the flow path;
a coupling portion providing fluid communication between the inlet and the outlet; and
a diverter positioned between the inlet and the outlet, the diverter including a baffle that inhibits fluid backflow from the outlet to the inlet.

2. The backflow preventer of claim 1, wherein the baffle directs fluid backflow toward a periphery of the coupling portion.

3. The backflow preventer of claim 2, wherein the first check valve includes a frame, a portion of the frame spaced from a side wall of the coupling portion to form a cavity, and wherein fluid backflow diverted to the periphery of the coupling portion can accumulate in the cavity.

4. The backflow preventer of claim 1, wherein the coupling portion includes a discharge port for receiving fluid backflow, wherein the baffle directs fluid backflow toward the discharge port.

5. The backflow preventer of claim 4, wherein the discharge port is located proximate an upstream end of the coupling portion.

6. The backflow preventer of claim 1, wherein the first check valve includes a frame and a valve body, the valve body being removable from the frame while the frame remains mounted in the coupling portion, wherein the baffle is one of a plurality of baffles, and wherein a cross sectional area of the valve body is blocked from fluid backflow by the plurality of baffles.

7. The backflow preventer of claim 1, wherein the coupling portion includes an access port, wherein the diverter is insertable through the access port.

8. The backflow preventer of claim 7, wherein the access port includes a removable cover, and wherein the diverter is shaped such that it can be removed from the coupling portion through the access port when the removable cover is removed.

9. The backflow preventer of claim 7, wherein the access port includes a removable cover, and wherein the diverter is attached to the removable cover.

10. The backflow preventer of claim 1, wherein the diverter includes a first baffle and a second baffle, the second baffle being movable between a first position and a second position.

11. The backflow preventer of claim 10, wherein fluid flow in a downstream direction biases the second baffle to the second position, wherein the second baffle returns to the first position in the absence of fluid flow in the downstream direction.

12. The backflow preventer of claim 1, wherein the diverter includes a plurality of flaps, the plurality of flaps movable between a first configuration and a second configuration, the plurality of flaps engaging each other to block fluid flow in the first configuration, and the plurality of flaps at least partially spaced apart to form an opening for allowing fluid flow therethrough in the second configuration.

13. The backflow preventer of claim 12, wherein fluid flow in a downstream direction can bias the plurality of flaps from the first configuration to the second configuration.

14. The backflow preventer of claim 1, wherein the diverter is rotatably coupled to a sidewall of the coupling portion.

15. The backflow preventer of claim 1, wherein the diverter is movable between a first position and a second position, the second position being less obstructive to fluid flow in a downstream direction than the first position, the first position of the diverter obstructing fluid backflow from the outlet from passing through the first check valve.

16. The backflow preventer of claim 1, wherein the diverter includes a first plate and a second plate each rotatable about a pivot member.

17. The backflow preventer of claim 1, wherein the diverter includes a floating member, the floating member sealing against a seat in the absence of fluid flow in a downstream direction.

18. The backflow preventer of claim 17, wherein the floating member is a sphere.

19. The backflow preventer of claim 17, wherein the coupling portion includes a receptacle offset from an inlet axis, the receptacle configured to retain the floating member in conditions of fluid flow in the downstream direction.

20. The backflow preventer of claim 1, wherein the diverter includes a helical panel, the helical panel prohibiting fluid flow in a direction parallel to an inlet axis through the diverter.

21. The backflow preventer of claim 1, wherein the diverter includes a plate having a plurality of openings therethrough, each of the plurality of openings having a nozzle.

22. The backflow preventer of claim 21, wherein the nozzles are configured to allow fluid flow through the plurality of openings in a downstream direction and to prohibit fluid flow through the plurality of openings in a backflow direction.

23. The backflow preventer of claim 1, wherein the diverter is positioned between the first check valve and the second check valve.

24. The backflow preventer of claim 1, wherein the diverter is positioned between the second check valve and the outlet.

25. The backflow preventer of claim 24 further comprising a discharge port positioned between the diverter and the outlet.

26. The backflow preventer of claim 1 further comprising:
a first discharge port positioned between the diverter and the outlet; and
a second discharge port positioned between a portion of the first check valve and the second check valve.

27. The backflow preventer of claim 26, wherein the first discharge port and the second discharge port are each coupled to a single relief valve.

28. A backflow preventer comprising:
an inlet;
outlet positioned in a stacked configuration with respect to the inlet;
a pipe section, the pipe section housing a first check valve and a second check valve downstream of the first check valve;
a diverter positioned between the first check valve and the second check valve, the diverter including a baffle that inhibits fluid backflow from a central portion of the pipe section and diverts fluid backflow to a periphery of the pipe section; and
a discharge port in a side wall of the pipe section.

29. The backflow preventer of claim 28, wherein the discharge port is located proximate the first check valve, the discharge port fluidly downstream of the first check valve.

30. The backflow preventer of claim 28, wherein the first check valve includes a frame, a portion of the frame spaced from the side wall of the pipe section to form a cavity, and wherein fluid backflow diverted to the periphery of the pipe section can accumulate in the cavity.

31. The backflow preventer of claim 28, wherein the first check valve includes a frame and a valve body, the valve body being removable from the frame while the frame remains mounted in the pipe section, wherein the baffle is one of a plurality of baffles, and wherein a cross sectional area of the valve body is blocked from fluid backflow by the plurality of baffles.

32. The backflow preventer of claim 28, wherein the pipe section includes an access port, wherein the diverter includes a base portion that is at least partially received in the access port.

33. The backflow preventer of claim 32, wherein the access port includes a removable cover, and wherein the diverter is shaped such that it can be removed from the pipe section through the access port when the removable cover is removed.

34. A backflow preventer comprising:
a pipe section having an inlet and an outlet, the inlet and the outlet being arranged in a stacked configuration, the pipe section housing a first check valve and a second check valve downstream of the first check valve;
a discharge port in a sidewall of the pipe section; and
a diverter positioned between the first check valve and the second check valve, the diverter including a baffle that blocks fluid backflow from a central portion of the pipe section and diverts the fluid backflow to a periphery of the pipe section.

35. The backflow preventer of claim 34, wherein the baffle is angled such that fluid backflow is guided towards the discharge port.

36. The backflow preventer of claim 34, wherein the diverter includes an end wall adjacent the sidewall of the pipe section, wherein a lower portion of the baffle and a lower portion of the end wall are connected to at least partially form a cavity for accumulating fluid backflow, and wherein the diverter includes a mouth at a lower end of the cavity for discharging fluid backflow.

37. The backflow preventer of claim 36, wherein the mouth is aligned with the discharge port to direct fluid backflow to the discharge port.

38. The backflow preventer of claim 34, wherein the pipe section includes an access port, wherein the diverter includes a base portion that is at least partially received in the access port.

39. The backflow preventer of claim 38, wherein the diverter includes an end wall opposite the base portion, and wherein the end wall abuts the sidewall of the pipe section and the base portion at least partially engages the access port to retain the diverter in the pipe section.

40. The backflow preventer of claim 34, wherein the diverter includes a first baffle and a second baffle, the second baffle movable relative to the second baffle.

41. A backflow preventer comprising:
an inlet;
an outlet aligned with the inlet in a stacked configuration;
a coupling portion providing fluid communication between the inlet and the outlet, the coupling portion including a first check valve and a second check valve, the first check valve positioned upstream of the second check valve, the first check valve including a first valve component moveable between engaging an upper end of a first valve frame to prohibit flow through the first check valve and being at least partially spaced apart from the upper end of the first valve frame to permit flow through the first check valve; and
a discharge port for expelling fluid from the outlet, the discharge port positioned on a sidewall of the coupling portion and at least partially upstream of the upper end of the first valve frame.

42. The backflow preventer of claim 41, wherein the discharge port is elongated in a direction that is perpendicular to a fluid flow direction from the inlet to the outlet.

43. The backflow preventer of claim 41, wherein the discharge port is positioned entirely upstream of the upper end of the first valve frame.
